(19) United States
(12) Patent Application Publication
(10) Pub. No.: US 2025/0310992 A1
(43) Pub. Date: Oct. 2, 2025

(54) LOW LATENCY COMMUNICATION IN UNLICENSED SPECTRUM

(71) Applicant: Nokia Technologies Oy, Espoo (FI)

(72) Inventors: Claudio ROSA, Aalborg (DK); Koen DE SCHEPPER, Antwerp (BE); Tao TAO, Shanghai (CN); Oana-Elena BARBU, Aalborg (DK); Nuno Manuel KIILERICH PRATAS, Aalborg (DK); Lorenzo GALATI GIORDANO, Stuttgart (DE); Karsten PETERSEN, Aalborg (DK)

(21) Appl. No.: 18/873,167

(22) PCT Filed: Jun. 21, 2022
(86) PCT No.: PCT/CN2022/100234

§ 371 Date: Dec. 9, 2024

(51) Int. Cl. H04W 74/0808; H04W 16/14; H04W 72/512

(52) U.S. Cl. CPC H04W 74/0808; H04W 16/14; H04W 72/512

(57) ABSTRACT

Embodiments of the present disclosure relate to methods, devices, apparatuses, and computer readable medium for low latency communication in unlicensed spectrum. The method comprises transmitting, by a device, latency information to at least one other device for adjusting a channel occupancy time, COT, of the at least one other device. The latency information is associated with a first maximum tolerable latency for a first data transmission performed by the first device on an unlicensed spectrum.

### FIELD

Embodiments of the present disclosure generally relate to the field of telecommunication and, in particular, to devices, methods, apparatus, computer readable storage media and systems for low latency communication in unlicensed spectrum.

### BACKGROUND

In recent years, more and more electronic devices are required to access a data network via a base station, an access point, a transmit and receive point, a TRP, and so on. In turn, various techniques have been developed to enhance the throughput of data transmissions to the data network. In one solution, one or more unlicensed spectrum channels are preconfigured. When detecting traffic data to be transmitted, the electronic devices may access and occupy an unlicensed spectrum channel for a time period based on channel sensing techniques, in order to perform data communication. For example, the electronic devices may use listen before talk, LBT, or clear channel assessment, CCA, in a contention window to sense whether the unlicensed spectrum is occupied. If the unlicensed channel is determined to be clear or not occupied, the electronic device may access and occupy this unlicensed channel for a preconfigured channel occupancy time, COT. In addition to the throughput requirement, communication latency requirement is further customized for different traffics or electronic devices. The traffic may be prioritized based on communication requirements comprising at least a latency requirement. In order to meet communication requirements, the data transmission for the traffic having a different priority may be preconfigured with a different contention window and a different COT. However, for a data transmission for the traffic with extreme low latency requirement, the preconfigured CW and COT may be insufficient.

### SUMMARY

In general, example embodiments of the present disclosure provide a solution for low latency communication in unlicensed spectrum.

In a first aspect, there is provided a device. The device comprises at least one processor; and at least one memory storing instructions that, when executed by the at least one processor, cause the device at least to transmit latency information to at least one other device for adjusting a channel occupancy time, COT, of the other device. The latency information is associated with a first maximum tolerable latency for a first data transmission performed by the device on an unlicensed spectrum.

In a second aspect, there is provided a device. The device comprises at least one processor; and at least one memory storing instructions that, when executed by the at least one processor, cause the device at least to receive, from another device, latency information for adjusting a COT of the device. The latency information is associated with a first maximum tolerable latency for a first data transmission performed on an unlicensed spectrum by the other device. The device is further configured to, in response to determining, based on the latency information, that a COT preconfigured for the unlicensed spectrum is unable to support the first maximum tolerable latency, determine a different COT for data communication to be performed.

In a third aspect, there is provided a method. The method comprises: transmitting,

by a device to at least another device, latency information for adjusting a COT of the other device. The latency information is associated with a first maximum tolerable latency for a first data transmission performed by the device on an unlicensed spectrum.

In a fourth aspect, there is provided a method. The method comprises: receiving, at a device and from another device, latency information for adjusting a COT of the device.

The latency information is associated with a first maximum tolerable latency for a first data transmission performed on an unlicensed spectrum by the other device; and in response to determining that the COT preconfigured for the unlicensed spectrum is unable to support the first maximum tolerable latency based on the latency information, determining a different COT for data communication to be performed.

In a fifth aspect, there is provided an apparatus. The apparatus comprises: means for transmitting latency information to at least one other apparatus for adjusting a channel occupancy time, COT, of the at least one other apparatus. The latency information is associated with a first maximum tolerable latency for first data transmission performed by the apparatus on an unlicensed spectrum.

In a sixth aspect, there is provided an apparatus. The apparatus comprises: means for receiving, from another apparatus, latency information for adjusting a COT of the apparatus. The latency information is associated with a first maximum tolerable latency for a first data transmission performed on an unlicensed spectrum by the other apparatus; and means for, in response to determining that a second channel occupancy time, COT, preconfigured for the unlicensed spectrum is unable to support the first maximum tolerable latency based on the latency information, determining a different COT for data communication to be performed.

In a seventh aspect, there is provided a non-transitory computer readable medium comprising program instructions for causing an apparatus to perform at least the method according to the third or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a signaling process for low latency communication in unlicensed spectrum according to some example embodiments of the present disclosure;

FIG. 3A illustrates a set of preconfigured COTs associated with devices according to some example embodiments of the present disclosure;

FIG. 3B illustrates a set of adjusted COTs associated with devices according to some example embodiments of the present disclosure;

FIG. 4 illustrates a flowchart of an example method for low latency communication at a device according to example embodiments of the present disclosure;

FIG. 5 illustrates a flowchart of an example method for low latency communication at a device according to example embodiments of the present disclosure;

FIG. 6 illustrates a flowchart of an example method for low latency communication at a device according to example embodiments of the present disclosure;

FIG. 7 illustrates a flowchart of an example method for low latency communication at a device according to example embodiments of the present disclosure;

FIG. 8 illustrates a simplified block diagram of an apparatus that is suitable for implementing example embodiments of the present disclosure; and

FIG. 9 illustrates a block diagram of an example computer readable medium in accordance with example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described for the only purpose of illustration and helping those skilled in the art to understand and implement the present disclosure, without suggesting any limitation to the scope of the disclosure. The disclosure described herein can be implemented in various manners other than those described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is within the knowledge of one skilled in the art to affect such feature, structure, or characteristic in connection with other embodiments regardless of whether it is explicitly described or not.

It shall be understood that, although the terms “first” and “second” etc. may be used herein to describe various elements, these elements should not be limited by these terms. These terms are used to distinguish one element from another only. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “has,” “having,” “includes,” and/or “including,” when used herein, specify the presence of stated features, elements, and/or components, etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Wireless Local Area Network (WLAN), Long Term Evolution (LTE), LTE-Advanced (LTE-A), Wideband Code Division Multiple Access (WCDMA), High-Speed Packet Access (HSPA), Narrow Band Internet of Things (NB-IoT). Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. Furthermore, the scope of the present disclosure is not to be understood as limited only to the aforementioned systems.

As used herein, the term “network device” refers to a node in a communication network via which a terminal device accesses the network and receives services. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), an Integrated Access and Backhaul (IAB) node, a relay, a low power node such as a femto, a pico, and so forth, depending on the applied terminology and technology. The network device is allowed to be defined as part of a gNB for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, a wireless customer premise equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device,” “communication device,” “terminal,” “user equipment,” and “UE” may be used interchangeably.

As mentioned above, for the electronic device performing the data transmission with extreme low latency requirement, the preconfigured CW and COT specific to the data transmission or the electronic device may be insufficient. In some situations, even if the electronic device performing the data transmission having extreme low latency requirement is preconfigured with the contention window and COT that has a higher priority, the latency requirement between two consecutive data transmissions of the device cannot be guaranteed. For example, the maximum tolerable latency of the device may be shorter than the interval of two consecutive data transmissions of the device, because COTs of other devices on the same unlicensed spectrum channel between the two consecutive data transmissions are longer than the maximum tolerable latency. Specifically, the main bottleneck for providing low latency communications in unlicensed spectrum channels, for example, at 2.4, 5, and 6 GHz, is channel access. Unlicensed channels can be blocked by an inter-system interferer transmitting on the same unlicensed channel. As the channel occupancy time, COT, in the above bands can be as large as 8 to 10 ms, achieving low latency communications is difficult if the unlicensed channel becomes interfered/occupied during the COT duration.

In one solution, the maximum duration of a COT is determined based on the priority of the data traffic, i.e. on the Channel Access Priority Class, CAPC. The relation between the maximum COT and the CAPC is provided in table 1 as below.

TABLE 1

| Channel | | | | | | |
|---|---|---|---|---|---|---|
| Access | | | | | | |
| Priority | | | | | | allowed CWₚ |
| Class (p) | mₚ | CW_{min, p} | CW_{max, p} | T_{m cot, p} | | size |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | 15, 31, 63} |
| 4 | 7 | 15 | 1023 | 8 or 10 | ms | 15, 31, 63, 127, |
| | | | | | | 255, 511, 1023} |

However, even if the transmission of data traffic corresponding to a different priority uses a different length of the contention window and a different COT, the selection of a specific contention window and COT is still only based on the priority of the data traffic being transmitted, i.e. it cannot adapt to other communication requirements, for example, a low communication latency requirement by a nearby device. Accordingly, a mechanism for dynamically adjusting COTs among a plurality of electronic devices based on the maximum tolerable latency of at least one of the devices may be further considered.

In order to solve the above and other potential problems, embodiments of the present disclosure provide an improved mechanism for low latency communication in unlicensed spectrum. According to the mechanism for low latency communication in unlicensed spectrum, a device is configured to transmit to at least one other device latency information for adjusting a COT of the at least one other device. The latency information is associated with a first maximum tolerable latency for a first data transmission by the device performed on an unlicensed spectrum. Without any limitation, the term “spectrum” and the term “channel” may be interchangeably used in this disclosure.

In this way, this device may broadcast the latency information associated with the performed data transmission to potential interferer devices around, or in proximity of, this device, such that these interferer devices may respectively adjust their COTs on the unlicensed channel for fulfilling the latency requirement of data transmission performed by this device.

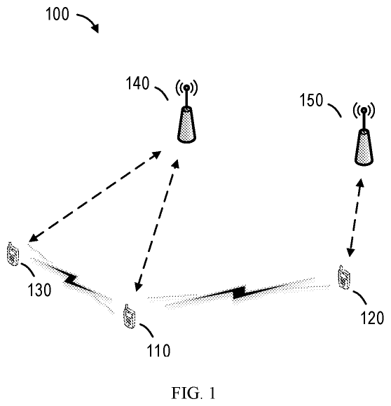

Example embodiments of the present disclosure for low latency communication in unlicensed spectrum will be described below with reference to FIGS. 1 to 9.

FIG. 1 illustrates an example network environment 100 in which embodiments of the present disclosure can be implemented. As shown in FIG. 1, the network environment 100, which may be a part of a communication network, comprises a terminal device 110, a terminal device 120, a terminal device 130, a network device 140 and a network device 150. In this disclosure, for discussion clarity and without any limitation, the terminal device 110 may be referred to as a first device 110, the terminal device 120 a second device 120, and the terminal device 130 a third device 130. The network device 140 may be referred to as a first network device 140 and the network device 150 may be referred to as a second network device 150.

As shown in FIG. 1, the first device (it may be a terminal device or a network device such as an access point) 110 and the third device (it also may be a terminal device or a network device such as an access point) 130 may access a data network via the first network device 140. The second device (it also may be a terminal device or a network device such as an access point) 120 may access the data network via the second network device 150. It should be understood that the number of devices as illustrated in FIG. 1 is for the purpose of illustration only, without suggesting limitations to the present disclosure.

In some embodiments, terminal devices served by a network device may perform data communication associated with certain traffic on spectrum channels as indicated by the network device. In some embodiments, the indicated spectrum channel comprises one or more unlicensed spectrum channels. In this case, terminal devices such as the first, second, and third devices 110, 120 and 130 are required to perform a channel access procedure, for example, an LBT or CCA procedure, before performing data communication. Once a device is not “blocked” by another device, i.e., the unlicensed spectrum channel is determined to be clear or un-occupied during a corresponding contention window, this device may perform data communication for certain traffic during a COT preconfigured for the traffic or this device. Otherwise, i.e., when this device is “blocked” by another device, this device has to wait to perform another channel access procedure in a next contention window; in some other embodiments, this device does not need to perform another channel access procedure, but the ongoing channel access procedure may only succeed when the channel is no longer “blocked.”

The communications in the network environment 100 may conform to any suitable standards including, but not limited to, IEEE 802.11 standard specifications including IEEE 802.11be, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), and/or any further communication protocols.

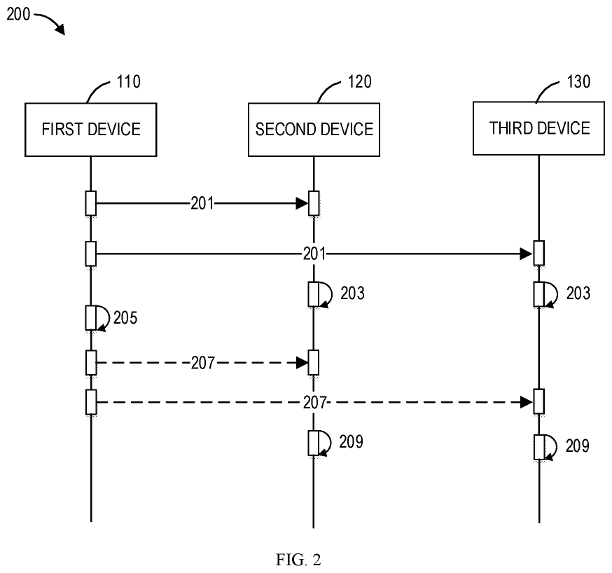

Principles and implementations of the present disclosure will be described in detail below with reference to FIGS. 2 to 5.

FIG. 2 illustrates a signaling process 200 for low latency communication in an unlicensed spectrum according to some example embodiments of the present disclosure. For purpose of discussion, the signaling process 200 will be described with reference to FIG. 1.

In the signaling process 200, at step 201, the first device 110 transmits latency information to at least one other device for adjusting a COT of the at least one other device. In this example, the other device may comprise the second device 120, or the third device 130, or both of the second and third devices 120 and 130. The latency information is associated with a first maximum tolerable latency for a first data transmission performed on an unlicensed channel by the first device 110.

In some embodiments, when detecting the first data transmission to be performed on the unlicensed channel, the first device 110 may determine whether the first data transmission requires low latency. If the first data transmission is determined to require the low latency, the first device 110 may determine the maximum tolerable latency of this data traffic, and transmit the latency information associated with the determined maximum tolerable latency. In addition or alternatively, without determining whether the first data transmission requires low latency, the first device 110 may directly determine the maximum tolerable latency of this first data transmission and transmit the latency information associated with the determined maximum tolerable latency. Regarding the first maximum tolerable latency, in some embodiments, the first maximum tolerable latency may comprise a tolerable latency (which may be referred to as a third latency) between consecutive data transmissions for the data traffic. In addition, the first maximum tolerable latency (which may be referred to as a fourth latency) may comprise a latency for survival time of the data traffic. For example, this fourth latency may be the service latency requirement taking the survival time into account.

For transmitting the latency information in an efficient way, existing information field may be reused. In some embodiments, the first device 110 may transmit the latency information in a preamble for the data traffic. According to example embodiments of the disclosure, the network device 140 may comprise an access point, AP, in a Wi-Fi access network. In this case, the first device 110 may include the latency information into a Wi-Fi preamble for the first data transmission and transmit the Wi-Fi preamble accordingly. In addition or alternatively to the preamble, the first device 110 may transmit the latency information in a specific message. In some other embodiments, the first device 110 may transmit the latency information using any other suitable approaches.

In some embodiments, the first device 110 may broadcast the latency information to potential interferer devices. In some embodiments, the first device 110 may sense the other devices which also contend for the same unlicensed channel. Then, the first device 110 may transmit the latency information to these devices that contend for the same unlicensed channel.

For example, the first device 110 may detect a received signal power on the unlicensed channel based on a respective signal transmitted by another device on the unlicensed channel. If the received signal power is above a predetermined power threshold, the first device 110 may determine the corresponding other device as the potential interferer device. According to the propagation characteristics of a radio signal, the received signal power is associated with the distance between the first device 110 and the other device. Accordingly, the predetermined power threshold may correspond to a certain distance from the first device 110. As such, the first device 110 may determine the number of potential interferer devices and the identities of the potential interferer devices within the certain distance from the first device 110 based on the received signal on the unlicensed channel. Accordingly, the first device 110 may only transmit the latency information to these potential devices. As shown at step 201 in FIG. 2, the second device 120 and the third device 130 may be the example potential interferer devices. In turn, the first device 110 may only transmit the latency information to the second device 120 and the third device 130.

In addition or alternatively, without determining the potential interferer devices, the first device 110 may directly broadcast the latency information at a predetermined transmitting power. In some other embodiments, the first device 110 may transmit only the latency information without involving the above steps.

The latency information associated with the maximum tolerable latency may indicate the maximum tolerable latency of the first data transmission in various manners.

In an example, the latency information may be indicative of a first time period associated with the first maximum tolerable latency. In some embodiments, the latency information may indicate the maximum tolerable latency directly.

Moreover, at the first device 110, the maximum COT (which may be referred to as COT 1 in the following) preconfigured for first data transmission on the unlicensed channel may be adjusted to adapt to the maximum tolerable latency of the first data transmission. In some embodiments, upon the unlicensed channel being determined to be clear, the first device 110 may perform data communication of the first data transmission based on the adjusted COT (which may be referred to as COT 10). For example, the first device 110 may perform data communication of the first data transmission using the COT 10. Regarding the adjustment from COT 1 to COT 10, the first device 110 may select the COT 10 from a set of predefined COTs based on the maximum tolerable latency. In some embodiments, a first set of associations between a set of COT values and a set of maximum tolerable latencies is predefined, in which at least one of the first set of COTs is associated with a respective maximum tolerable latency in the set of maximum tolerable latencies. Upon the maximum tolerable latency for the first data transmission being determined, the first device 110 may select COT 10 from the set of COTs corresponding to the maximum tolerable latency in the set of latencies which is closest to the determined maximum tolerable latency.

In some embodiments, there may be other relationship between the COT and the maximum tolerable latency. For example, the COT 10 may be determined based on dividing the maximum tolerable latency by a preconfigured number. In some other embodiments, the COT 10 may be determined based on subtracting the maximum tolerable latency by a preconfigured value. In some embodiments, the dependency of the COT and the respective tolerable latency may be preconfigured in any other manners. In addition or alternatively, the first device may not adjust the COT 1 when the COT 1 is shorter than or equal to the appropriate COT for the maximum tolerable latency, for example, a possible COT 10 selected from the set of predetermined COTs based on the maximum tolerable latency. In this case, the first device may directly perform data communication for the data traffic using the original COT 1 preconfigured for the data traffic, the first device 110 or the unlicensed channel.

In addition to directly indicating the maximum tolerable latency or alternatively, the latency information may indicate COT 10 which is further selected by the first device 110 based on the maximum tolerable latency.

In addition or alternatively, if the first device 110 has sensed or determined the number of potential interferer devices that contend for the same unlicensed channel, the latency information may indicate a suggested COT (which may be referred to as a second COT) for these potential interferer devices. In some embodiments, the number of potential interferer devices may be determined by means of the received signal power as discussed above or by means of sensing. In some embodiments, the first terminal device 110 may determine the number of potential interferer devices in any other ways.

In some embodiments, the second COT (suggested COT) may be equal to a value of dividing the maximum tolerable latency by (the number of potential interferer devices +Δ), wherein Δ may be a protection margin that accounts for imperfection in sensing the correct number of potential interferer devices that contend for the channel during a certain time window.

In turn, at the second device 120 and the third device 130, if the latency information (for example, in the Wi-Fi preamble) transmitted from the first device is detected, then the second device 120 and the third device 130 may adjust their respective COTs accordingly.

At step 203, the second device 120 (or third device 130) determines whether the respective COT is able to support the first maximum tolerable latency based on the received latency information. To clarify, responding operations for the received latency information are discussed with reference to the second device 120, and the operations for the third device 130 may be performed likewise. If the maximum COT of the second device 120 (which may be referred to as COT 2) preconfigured for the data transmission on unlicensed channel is able to support the first maximum tolerable latency, the second device 120 may perform corresponding data communication of the second device 120 based on COT 2. Otherwise, the second device 120 selects a different COT (which may be referred to as COT 20) to perform data communication.

In some embodiments, as discussed above, the latency information indicates the first maximum tolerable latency directly. The second device 120 may adjust the COT 2 to the different other COT based on a second set of associations between a predefined set of COTs and a set of maximum tolerable latencies, in which at least one of the second set of COTs is associated with a respective maximum tolerable latency value in the set of maximum tolerable latencies. The at least one COT corresponding to the maximum tolerable latency value supports the maximum tolerable latency requirement accordingly. The second device 120 may determine the longest one of the at least one COT corresponding to the maximum tolerable latency as the appropriate COT 20. In some embodiments, the second set of associations may be the above first set of associations discussed with the first device 110. In some other embodiments, the second set of associations may be another set predetermined for the responding devices 120 and 130. In some further embodiments, the set of associations may be specific to a device. In addition or alternatively, if the preconfigured COT 2 is shorter than the appropriate COT 20, the second device 120 may directly perform the data communication based on the preconfigured COT 2 without using COT 20.

In addition or alternatively, as discussed above, the latency information indicates COT 10 used by the first device 110. In this case, the COT 10 is determined to be the different COT, i.e., COT 20, of the second device 120 for data communication to be performed. Accordingly, the second device 120 may perform the data communication based on the COT 20 which has the same time length as COT 1. In addition or alternatively, if the preconfigured COT 2 is shorter than the COT 10 used by the first device 110, the second device 120 may directly perform the data communication based on the preconfigured COT 2 without using COT 20 having the first time period.

In addition or alternatively, as discussed above, the latency information may also indicate suggested COT determined by the first device 110 based on the number of potential interferer devices that contend for the same unlicensed channel. In this case, the suggested COT is determined to be the different COT, i.e., COT 20, of the second device 120 for data communication to be performed. Accordingly, the second device 120 may perform the data communication based on a COT 20 that has the same time length as the suggested COT. In addition or alternatively, if the preconfigured COT 2 is shorter than the suggested COT, the second device 120 may directly perform the data communication based on the preconfigured COT 2 without using COT 20 having the first time period.

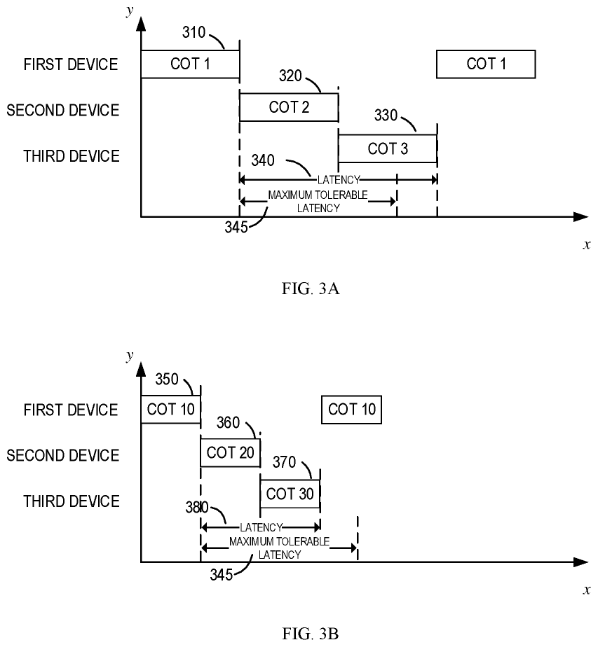

By means of operations as discussed above, the COTs associated with the first device 110, the second device 120, and the third device 130 may be adjusted based on the maximum tolerable latency associated with the first device 110 such that the latency of data communication for the first traffic is shorter than the maximum tolerable latency. For discussion clarity, the example advantages of these operations are illustrated by FIGS. 3A and 3B.

FIG. 3A illustrates a set of preconfigured COTs associated with devices 110, 120, and 130 according to some example embodiments of the present disclosure. For purpose of discussion, the COT 300A will be described with reference to FIGS. 1 and 2.

As illustrated in FIG. 3A, COT 1 310 is preconfigured for the first device 110, COT 2 320 is preconfigured for the second device 120, and COT 3 330 is preconfigured for the third device 130. Further, in this case, the time length 340 is the time elapsing between two consecutive data transmissions or receptions of the first device 110. However, in this example, the time length 340 is longer than the maximum tolerable latency 345. Accordingly, the latency requirement of the first data transmission cannot be guaranteed based on only the COTs preconfigured for the devices or the data traffics.

FIG. 3B illustrates a set of adjusted COTs associated with devices 110, 120, and 130 according to some example embodiments of the present disclosure. As shown in FIG. 3B, a different COT 10 350 for the first device 110, a different COT 20 360 for the second device 120 and a different COT 30 370 for the third device 130 are shown. The COT 10 350 may be the appropriate COT (for example, the COT 10 as discussed above) selected by the first device 110 based on the maximum tolerable latency of data transmission of the first device. The COT 20 360 may be the appropriate COT (for example, the COT 20 as discussed above) selected by the second device 120 based on latency information signaled by the first device according to some embodiments. In addition, the COT 30 370 may be a COT 30 (for example, the COT 30 as discussed above) selected by the third device 130 based on latency information signaled by the first device according to some embodiments.

After adjustment for the COTs based on the maximum tolerable latency, the actual latency 340 (as shown in FIG. 3A) between two consecutive data transmissions or receptions of the first device 110 can be reduced to the time length 380 which is shorter than the maximum tolerable latency 345. In this way, the latency requirement of the first data transmission can be guaranteed based on respectively adjusting the COTs by devices dynamically.

Returning back to FIG. 2, the latency information associated with the maximum tolerable latency may be further updated or released based on subsequent traffic requirements.

At step 205, in some embodiments, the first device 110 may update the first time period indicated by the latency information based on a second maximum tolerable latency for second data transmission to be performed. For example, the latency requirement may be different for different data traffics. The second maximum tolerable latency may be different from the first maximum tolerable latency. Once the first data transmission is terminated, the first device 110 may update the latency information. Further, at step 207, the first device 110 may transmit the updated latency information. In some embodiments, the updated latency information may indicate a second time period. The second time period may be determined based on the second maximum tolerable latency in the same way as the determination of the first time period based on the first maximum tolerable latency.

In some embodiments, the first device 110 may determine the second data transmission to be performed and update the latency information based on the maximum tolerable latency of the second data transmission. In some embodiments, at least one of the first data transmission and the second data transmission comprises low latency communication traffic.

In addition or alternatively, at step 207, the first device 110 may transmit a release indication for the maximum tolerable latency. The release indication is indicative of releasing a requirement for the maximum tolerable latency. For example, if the second data transmission to be performed has no constraint with respect to the latency or there is no further data traffic to be performed, the first device 110 may transmit the release indication. For example, the first device 110 may add control information (for example, in the preamble) in its last low-latency packet for the first data transmission, and the control information indicates that tolerance to latency has increased.

At the second device 120 or the third device 130, at step 209, when receiving the updated latency information, they may perform operations that are similar to those for the first data transmission based on the updated latency information. In addition or alternatively, when receiving the release indication, the second device 120 or the third device 130 may reuse the COT 2 or 3 originally preconfigured for the respective device to perform data communication. For example, when receiving the release indication, the second device 120 or third device 130 is aware of the constraint on latency being released, and then the second device 120 or the third device 130 may adjust the COT back to the originally preconfigured COT.

In addition or alternatively, at step 209, without receiving the release indication or the updated latency information, the second device 120 or the third device 130 also may release the constraint associated with the latency information and adjust the COT 20 or 30 back to COT 2 or 3 automatically.

In some embodiments, the second device 120 or third device 130 may initiate a timer (which may be referred to as a first timer) when determining that the preconfigured COT 2 or 3 is unable to support the maximum tolerable latency signaled by the first device. Once the first timer expires, the second device 120 or third device 130 may adjust the COT 20 or 30 respectively back to the original preconfigured COT 2 or 3 for data communication to be performed. In an example, if a first predefined time length has elapsed, the first timer may be determined to be expired. In addition or alternatively, in some embodiments, upon receipt of the release indication, the first timer may be determined expired. In addition or alternatively, in some embodiment, upon receiving updated latency information associated with a second maximum latency and the preconfigured COT is determined to be able to support the second maximum latency, the first timer may be determined as expired.

In some embodiments the first timer may be triggered or re-initiated during running. In an example, if same latency information associated with the first maximum tolerable latency is received again, the first timer may be re-initiated. In another example, if updated latency information associated with the second maximum tolerable latency is received, the first timer may be re-initiated.

However, in this case, if the first device 110 performs a plurality of data transmissions having low latency requirement always, other devices may have no chance to use the original COT. To balance devices' permissions to transmit data, another timer (which may be referred to as a second timer) for the latency information may be set. For example, at the second device 120, in addition to the first timer, the second timer may be initiated when the latency information is received. For the second timer, regardless of what is communicated by the first device 110 (even if the first device 110 is transmitting data packets for the traffic having low latency requirement), the second device 120 may resume using the originally preconfigured COT 2 (without any constraint) if the second timer is determined to be expired. In an example, if a second predefined time length has elapsed, the second timer may be determined expired. The second predefined time length is significantly greater than the first predefined time length. In some embodiments, the second timer is configured to disable a re-initiation during running.

This is to guarantee fairness and prevent the first device 110 from imposing its own decision for too long.

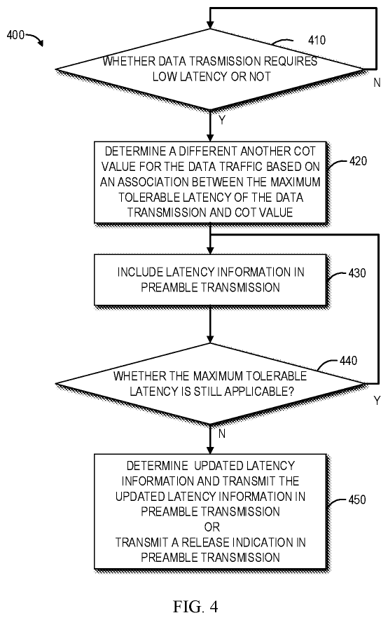

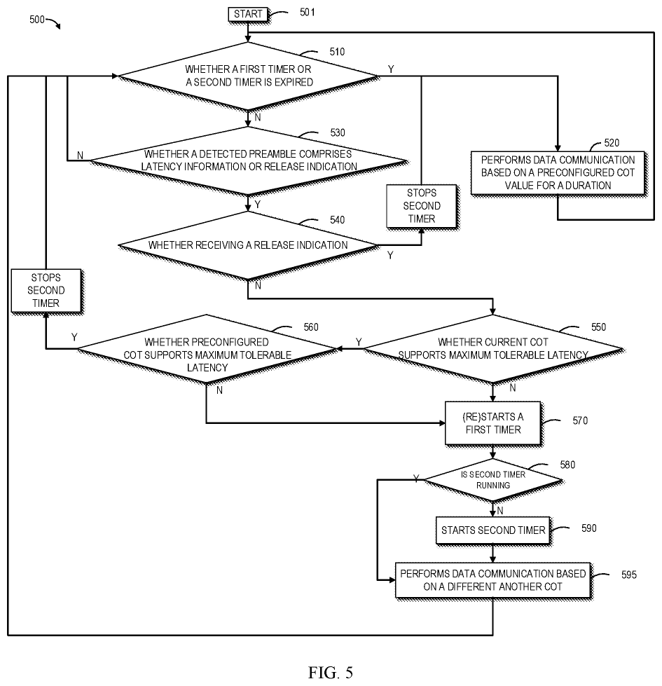

For further illustrating the technical details, the operations at the first device 110 and the second device 120 or the third device 130 may be further discussed with reference to FIGS. 4 and 5.

FIG. 4 illustrates a flowchart 400 of an example method for low latency communication at a device according to example embodiments of the present disclosure.

The flowchart 400 may be implemented at the first device 110 as discussed above.

At block 410, the first device 110 may determine whether data transmission to be performed has low latency requirement or not. If the data transmission requires no low latency, the method returns to block 410. Otherwise, it proceeds to block 420.

At block 420, if the data traffic has a low latency requirement, the first device 110 may determine another COT value different from the preconfigured COT based on an association between the maximum tolerable latencies and COT values.

At block 430, the first device 110 may include the latency information associated with the maximum tolerable latency in a preamble transmission for the data transmission, for example, a Wi-Fi preamble.

At block 440, the first device 110 may determine whether the maximum tolerable latency is still applicable. If the maximum tolerable latency is still applicable, the method returns to block 430.

If the maximum tolerable latency is not applicable, the method 400 proceeds to block 450, where the first device 110 may transmit a release indication or update the latency information as discussed above.

FIG. 5 illustrates a flowchart 500 of an example method for low latency communication at a device according to example embodiments of the present disclosure.

The flowchart 500 may be implemented at any of the second device 120 and the third device 130 as discussed above. To clarify, the flowchart 500 is discussed with reference to the second device 120

The operation flow of the second device 120 starts at block 501.

At block 510, the second device 120 determines whether at least one of a first timer and a second timer which is set for received latency information is expired. If at least one of the first timer and the second timer is determined to be expired, the method proceeds to block 520.

At block 520, the second device 120 may perform data communication based on a preconfigured COT value, for example, COT 2, for certain duration.

If neither the first timer nor the second timer have expired (at block 510), the method proceeds to block 530. At block 530, the second device 120 determines whether a detected preamble comprises latency information or a release indication. If there is no latency information or a release indication in the detected preamble, the method returns to block 510. Otherwise, the method proceeds to block 540.

At block 540, the second device 120 further determines whether the release indication is received. If the release indication is received, the method stops the second timer and then the method proceeds to the block 520. Otherwise, the method proceeds to block 550.

At block 550, the second device 120 determines whether the current used COT supports maximum tolerable latency based on the latency information. If the current used COT is unable to support maximum tolerable latency, the method proceeds to block 570. Otherwise, the method proceeds to block 560.

At block 560, the second device 120 determines whether the preconfigured COT supports the maximum tolerable latency based on the latency information. If the preconfigured COT is able to support the maximum tolerable latency, the second device 120 stops the second timer and then returns to block 510. Otherwise, the method proceeds to block 570.

At block 570, the second device 120 initiates or starts the first timer, and then the method proceeds to block 580.

At block 580, the second device 120 determines whether the second timer is running. If yes, the method proceeds to block 595. Otherwise, the method proceeds to block 590, where the second timer is started, and then the method proceeds to block 595.

At block 595, the second device 120 performs data communication based on the COT different from the preconfigured COT, and then the method returns to block 510.

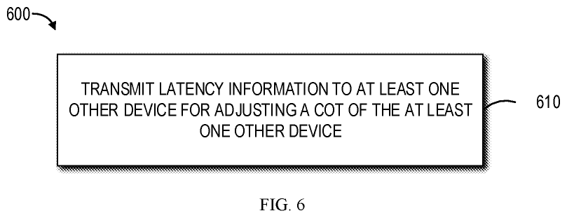

FIG. 6 illustrates a flowchart 600 of an example method for low latency communication at a terminal device according to example embodiments of the present disclosure. The method 600 can be implemented at the first device 110 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

As shown in FIG. 6, at 610, the first device 110 transmits to at least one other device 120 for adjusting a channel occupancy time, COT, of the at least one other device.

The latency information is associated with a first maximum tolerable latency for a first data transmission performed on an unlicensed spectrum by the first device 110.

In some embodiments, the first device 110 is further caused to transmit the latency information in a preamble for the first data transmission.

In some embodiments, the preamble comprises a Wi-Fi preamble.

In some embodiments, the latency information is indicative of a first channel occupancy time, COT, of the device for the first data transmission.

In some embodiments, the device is further configured to: determine a number of devices that contend for the unlicensed spectrum, and wherein the latency information indicates a second COT which is calculated by dividing the first maximum tolerable latency by the number of the devices.

In some embodiments, the first device 110 is further caused to: determine a number of devices that contend for the unlicensed spectrum, and wherein the latency information indicates a second COT which is calculated by dividing the first maximum tolerable latency by the number of the devices.

In some embodiments, the first time period is indicative of the first maximum tolerable latency.

In some embodiments, the first device 110 is further caused to: update the latency information based on a second maximum tolerable latency for a second data transmission to be performed, wherein the second maximum tolerable latency is different from the first maximum tolerable latency and wherein the updated latency information indicates a second time period determined based on the second maximum tolerable latency; and transmit, to the at least one other device, updated latency information indicating the second time period.

In some embodiments, the first device 110 is further configured to: transmit a release indication for the maximum tolerable latency, the release indication being indicative of releasing a requirement for the maximum tolerable latency.

In some embodiments, at least one of the first data transmission or the second data transmission comprises low latency communication traffic.

In some embodiments, the first maximum tolerable latency comprises at least one of: a third latency for one time of data transmission of the data traffic; or a fourth latency for survival time of the data traffic.

In some embodiments, the device 110 further comprises a transceiver.

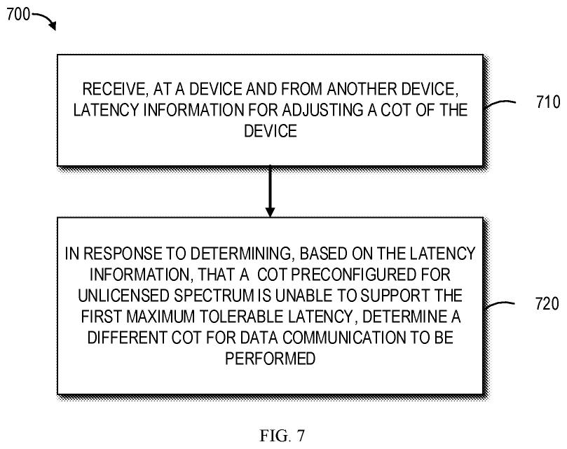

FIG. 7 illustrates a flowchart 700 of an example method for low latency communication at a terminal device according to example embodiments of the present disclosure. The method 700 can be implemented at the second device 120 or the third device 130 shown in FIG. 1. For the purpose of discussion, the method 700 will be described with reference to FIG. 1. It is to be understood that method 700 may further include additional blocks not shown and/or omit some shown blocks, and the scope of the present disclosure is not limited in this regard.

As shown in FIG. 7, at 710, the second device 120 receives latency information for adjusting a COT of the second device 120 from a first device 110. The latency information is associated with a first maximum tolerable latency for a first data transmission performed on an unlicensed spectrum by the first device 110.

At 720, in response to determining, based on the latency information, that COT preconfigured for the unlicensed spectrum is unable to support the first maximum tolerable latency, the second device 120 determines another (a different) COT for data communication to be performed.

In some embodiments, the second device 120 is further caused to receive the latency information in a preamble for the first data transmission.

In some embodiments, the preamble comprises a Wi-Fi preamble.

In some embodiments, the latency information is indicative of a first COT of the other device for the first data transmission; the device is further configured to: determine the first COT as the other COT.

In some embodiments, the latency information is indicative of a second COT, and wherein the second COT is calculated by dividing the first maximum tolerable latency by the number of the devices, the device is further configured to: determine the second COT as the other COT.

In some embodiments, the latency information is indicative of the first maximum tolerable latency and wherein the device is further configured to determine a different COT by: selecting another COT from a set of predefined COTs, the selected COT being the longest COT supporting the first maximum tolerable latency in the set of predefined COTs.

In some embodiments, the second device 120 is further caused to perform data communication based on the other COT.

In some embodiments, the device is further configured to: in response to detecting a first timer being expired, perform data communication based on the COT preconfigured for the unlicensed spectrum, the expiration of the first timer being detected based on at least one of: receiving a release indication for the maximum tolerable latency, the release indication being indicative of releasing a requirement for the maximum tolerable latency; receiving updated latency information associated with a second maximum tolerable latency, wherein the COT preconfigured for the unlicensed spectrum is determined to be able to support the second maximum tolerable latency based on the updated latency information; or a first predefined time length has elapsed.

In some embodiments, the first timer is configured to be initiated or re-initiated in response to at least one of: receiving the latency information and determining that the COT preconfigured for the unlicensed spectrum is unable to support the first tolerable maximum latency; or receiving the updated latency information and determining that the COT preconfigured for the unlicensed spectrum is unable to support the second maximum tolerable latency.

In some embodiments, the device is further configured to: in response to detecting a second timer being expired, perform data communication based on the COT preconfigured for the unlicensed spectrum, wherein the expiration of the second timer is detected based on a second predefined time length having elapsed, and wherein the second predefined time length is longer than the first predefined time length.

In some embodiments, the second timer is configured to: be initiated upon receiving the latency information; and disable a re-initiation during running.

In some embodiments, the first data transmission comprises low latency communication traffic.

In some embodiments, the first maximum tolerable latency comprises at least one of: a third latency for one time of data transmission of the data traffic; or a fourth latency for survival time of the data traffic.

In some embodiments, the device 120 further comprises a transceiver.

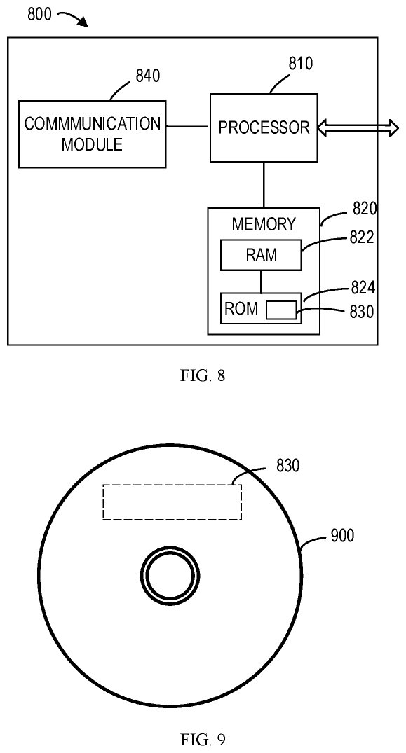

FIG. 8 is a simplified block diagram of a device 800 that is suitable for implementing embodiments of the present disclosure. The device 800 may be provided to implement the communication device, for example the first device 110, the second device 120, and the third device 130 as shown in FIG. 1. As shown, the device 800 includes one or more processors 810, one or more memories 820 coupled to the processor 810, and one or more transmitters and/or receivers (TX/RX) 840 coupled to the processor 810.

The TX/RX 840 may be configured for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a

Read Only Memory (ROM) 824, an electrically programmable read only memory (EPROM), a flash memory, a hard disk, a compact disc (CD), a digital video disk (DVD), and other magnetic storage and/or optical storage media. Examples of the volatile memories include, but are not limited to, a Random Access Memory (RAM) 822 and other volatile memories that will not last in the power-down duration.

A computer program 830 includes computer executable instructions that may be executed by the associated processor 810. The program 830 may be stored in the memory 820, for example in ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIG. 2. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out any of the methods 600 to 700 as described above with reference to FIGS. 6-7. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A device, comprising:
at least one processor; and
at least one memory storing instructions that, when executed by the at least one processor, cause the device at least to:
transmit latency information to at least one other device for adjusting a channel occupancy time, COT, of the at least one other device, the latency information being associated with a first maximum tolerable latency for a first data transmission performed by the device on an unlicensed spectrum.

32. The device of claim 31, wherein the device is further configured to transmit the latency information in a preamble for the first data transmission.

33. The device of claim 32, wherein the preamble comprises a Wi-Fi preamble.

34. The device of claim 31, wherein the latency information is indicative of a first channel occupancy time, COT, of the device for the first data transmission.

35. The device of claim 31, wherein the latency information is indicative of the first maximum tolerable latency.

36. The device of claim 31, wherein the device is further configured to:
update the latency information based on a second maximum tolerable latency for a second data transmission to be performed, wherein the second maximum tolerable latency is different from the first maximum tolerable latency; and
transmit, to the at least one other device, updated latency information indicating the second time period.

37. The device of any claim 31, wherein the device is further configured to:
transmit a release indication for the maximum tolerable latency, the release indication being indicative of releasing a requirement for the maximum tolerable latency.

38. The device of claim 31, wherein at least one of the first data transmission or the second data transmission comprises a low latency communication traffic.

39. The device of claim 31, wherein the first maximum tolerable latency comprises at least one of:
a third latency for one time of data transmission of the data traffic; or
a fourth latency for survival time of the data traffic.

40. The device of claim 31, further comprising a transceiver.

41. A device, comprising:
at least one processor; and
at least one memory storing instructions that, when executed by the at least one processor, cause the device at least to:
receive, from another device, latency information for adjusting a channel occupancy time, COT, of the device, the latency information being associated with a first maximum tolerable latency for a first data transmission performed by the other device on an unlicensed spectrum; and
in response to determining, based on the latency information, that a channel occupancy time, COT, preconfigured for the unlicensed spectrum is unable to support the first maximum tolerable latency, determine a different COT for data communication to be performed.

42. The device of claim 41, wherein the device is further configured to receive the latency information in a preamble for the first data transmission.

43. The device of claim 42, wherein the preamble comprises a Wi-Fi preamble.

44. The device of claim 41, wherein the latency information is indicative of a first COT of the other device for the first data transmission, and the device is further configured to:
determine the first COT as the different COT.

45. The device of claim 41, wherein the device is further configured to perform data communication based on the different COT.

46. The device of claim 41, wherein the device is further configured to:
in response to detecting a first timer being expired, perform data communication based on the COT preconfigured for the unlicensed spectrum, the expiration of the first timer being detected based on at least one of:
receiving a release indication for the maximum tolerable latency, the release indication being indicative of releasing a requirement for the maximum tolerable latency;
receiving updated latency information associated with a second maximum tolerable latency, wherein the COT preconfigured for the unlicensed spectrum is determined to be able to support the second maximum tolerable latency based on the updated latency information; or
a first time length has elapsed.

47. The device of claim 46, wherein the first timer is configured to be initiated or re-initiated in response to at least one of:
receiving the latency information and determining that the COT preconfigured for the unlicensed spectrum is unable to support the first tolerable maximum latency; or
receiving the updated latency information and determining that the COT preconfigured for the unlicensed spectrum is unable to support the second maximum tolerable latency.

48. The device of claim 41, wherein the first data transmission comprises a low latency communication traffic.

49. The device of claim 41, wherein the first maximum tolerable latency comprises at least one of:
a third latency for one time of data transmission of the data traffic; or
a fourth latency for survival time of the data traffic.

50. The device of claim 41, further comprising a transceiver.
